(19) United States
(12) Patent Application Publication
(10) Pub. No.: US 2015/0030296 A1
(43) Pub. Date: Jan. 29, 2015

(54) OPTICAL FIBER RIBBON

(71) Applicant: SUMITOMO ELECTRIC INDUSTRIES, LTD., Osaka-shi, Osaka (JP)

(72) Inventors: Itaru Sakabe, Yokohama-shi (JP); Tomoyuki Hattori, Yokohama-shi (JP)

(21) Appl. No.: 14/122,448

(22) PCT Filed: Oct. 3, 2012
(86) PCT No.: PCT/JP2012/075623

§ 371 Date: Nov. 26, 2013

(51) Int. Cl. G02B 6/44

(52) U.S. Cl. CPC G02B 6/4403
USPC 385/114

(57) ABSTRACT

An optical fiber ribbon 11 includes a plurality of optical fibers 12 which are formed of glass fibers 13 covered with resin layers 14, and arranged in parallel. The optical fibers 12 are covered with connecting material 15 to be integrated into the optical fiber ribbon 11. A peeling strength of the connecting material 15 with respect to outer peripheral faces of the optical fibers 12 is set to be from 0.1 N/mm to 10 N/mm.

### TECHNICAL FIELD

The present invention relates to an optical fiber ribbon which is formed by integrating a plurality of optical fibers into a tape-like shape.

### BACKGROUND ART

As internet service rapidly comes into widespread use, for the purpose of coping with rapid increase of demand for data communications, FTTH (Fiber to The Home) service which provides superfast data communication service, by directly connecting a communication provider to each home by means of optical fibers, has been widely developed. In this FTTH service, in order to drop the optical fibers to a subscriber's home, post-intermediate branching work in which an optical fiber ribbon which constitutes an aerial optical fiber cable is taken out and separated into a plurality of single optical fibers or a plurality of optical fiber groups including the optical fibers is conducted. Then, each separated single optical fibers or optical fiber groups is connected to an optical drop cable, and dropped into the subscriber's home.

As the optical fiber ribbon for easily conducting the post-intermediate branching work, there has been known such an optical fiber ribbon that resin for bonding a plurality of optical fibers together is parted in parting sections which are intermittently provided along a longitudinal direction of the optical fiber ribbon, and the resin remains in the parting sections, in a state continuously connected to non-parting sections in the longitudinal direction (Reference should be made to Patent Document 1, for example). In case of this optical fiber ribbon, a separating tool of a parting device is relatively moved in the longitudinal direction of the optical fiber ribbon in a state where a tip end of a fiber member of the separating tool is kept in contact with the resin. Then, the tip end of the fiber member enters into the resin of the optical fiber ribbon, and a part of the resin is scraped off thereby to form parting grooves. As the results, the resin which connects and fixes the adjacent optical fibers to each other is parted, and the adjacent optical fibers are separated by the parting grooves. In this manner, the optical fibers are separated into a plurality of single optical fibers or a plurality of optical fiber groups including optical fibers.

Moreover, there has been known such an optical fiber ribbon that adhesive strength of protective coating layers on outer peripheries of glass fibers which compose the optical fiber with respect to an integral coating layer for integrating a plurality of the optical fibers is from 0.4 g/cm to 10 g/cm, and excellent integral removability and separability into single optical fibers can be obtained (Reference should be made to Patent Document 2, for example).

### PRIOR ART DOCUMENT

### Patent Document

Patent Document 1: Japanese Patent No. 4055000
Patent Document 2: Japanese Patent Publication No. JP-A-2000-155248

### SUMMARY OF THE INVENTION

### Problems that the Invention is to Solve

When the optical fibers of the optical fiber ribbon are separated into a plurality of single optical fibers or a plurality of optical fiber groups including optical fibers for the post-intermediate branching work, the resin which integrates a plurality of the optical fibers (a coating surrounding the optical fibers) is sometimes peeled off from the optical fibers, and this resin which has been peeled off may become an obstacle to the branching work, in some cases.

Moreover, because the resin which has been peeled off must be separated from the optical fiber ribbon and disposed as waste, it is necessary to conduct the annoying separating work and disposing work.

An object of the invention is to provide an optical fiber ribbon which is excellent in branching workability, without generating resin to be disposed.

### Means for Solving the Problems

An optical fiber ribbon which can solve the above described problem includes a plurality of optical fibers which are formed of glass fibers coated with resin, and arranged in parallel, the optical fibers being connected with connecting material, and the optical fiber ribbon is characterized in that a peeling strength of the connecting material with respect to outer peripheral faces of the optical fibers is set to be from 0.1 N/mm to 10 N/mm.

In the optical fiber ribbon according to the invention, it would be preferable that in regions where the optical fibers are adjacent to each other, there exist some parts where the optical fibers are not connected with each other, intermittently along a longitudinal direction of the optical fibers.

In the optical fiber ribbon according to the invention, it would be preferable that there exist some parts where the connecting material is not applied, intermittently along the longitudinal direction.

In the optical fiber ribbon according to the invention, it would be preferable that notches are formed in the connecting material between the optical fibers, intermittently along the longitudinal direction.

In the optical fiber ribbon according to the invention, it would be preferable that in a sectional plane perpendicular to an axis of the optical fiber, a thickness of the connecting material in a direction perpendicular to an arranging direction of the optical fibers, in a region where the optical fibers are adjacent to each other, is smaller than an outer diameter of the optical fiber.

### Advantage of the Invention

According to the invention, even though the optical fibers are separated, the connecting material is kept in tight contact with the outer peripheral faces of the optical fibers, without being peeled off. As the results, it is possible to smoothly and reliably perform a succeeding branching work such as a connecting work with a drop cable, and to reduce a working time for the post-intermediate branching work. Moreover, because the connecting material will not be peeled off to become waste, it is possible to eliminate necessity of conducting annoying works such as separating the connecting material which has been peeled off from the optical fiber ribbon and disposing it as the waste.

### BRIEF DESCRIPTION OF THE DRAWINGS

FIG. 1 is a perspective view showing an optical fiber ribbon in a first embodiment according to the invention.

FIG. 2 is a sectional view of the optical fiber ribbon as shown in FIG. 1.

FIG. 3 is a plan view of the optical fiber ribbon, showing a branching work of the optical fiber ribbon in FIG. 1.

FIG. 4 is a sectional view of the optical fiber ribbon, showing the branching work in regions where the optical fibers are separated.

FIG. 5 is a plan view of the optical fiber ribbon, showing the branching work of the optical fiber ribbon, in a reference example.

FIG. 6 is a sectional view of the optical fiber ribbon, showing the branching work in regions where the optical fibers are separated, in the reference example.

FIG. 7 is a sectional view of the optical fiber ribbon, showing the branching work in the regions where the optical fibers are separated, in the reference example.

FIG. 8 is a sectional view of an optical fiber ribbon in a modified example.

FIG. 9 is a sectional view of an optical fiber ribbon in a second embodiment according to the invention.

FIG. 10 is a sectional view of the optical fiber ribbon in the second embodiment, in regions where the optical fibers are separated.

FIG. 11 is a perspective view of the optical fiber ribbon, as shown in FIG. 9.

FIG. 12 is a perspective view showing another example of the optical fiber ribbon in the second embodiment.

FIG. 13 is perspective views of an optical fiber ribbon in a third embodiment according to the invention.

### DESCRIPTION OF EMBODIMENTS

Now, the optical fiber ribbon in the embodiments according to the invention will be described, referring to the drawings.

### First Embodiment

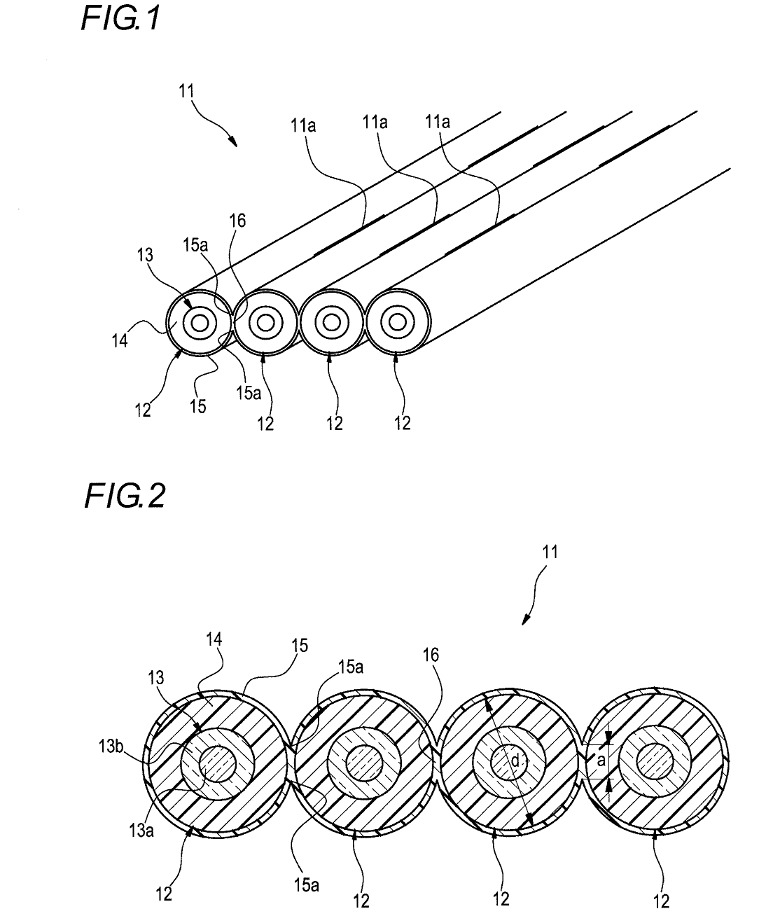

As shown in FIG. 1, an optical fiber ribbon 11 in the first embodiment includes a plurality of (four, in this embodiment) optical fibers 12, and formed by integrating these optical fibers 12 in a state arranged in parallel.

As shown in FIG. 2, the respective optical fibers 12 which compose this optical fiber ribbon 11 are formed by coating glass fibers 13 with coating layers 14 which are formed of resin. Each of the glass fibers 13 has a core 13a and a clad 13b surrounding the core 13a, and its outer diameter is 125 μm. The coating layers 14 are formed of resin of ultraviolet radiation hardening type, and respectively colored for the purpose of distinguishing the optical fibers 12 from each other. Each of these coating layers 14 may be formed by stacking a plurality of layers in a radial direction. As a structure having a plurality of layers, there are a two-layer structure having an inner layer and an outer layer which covers the inner layer, a three-layer structure having an inner layer, an outer layer, and a colored layer which covers the outer layer, and so on.

A plurality of the optical fibers 12 are arranged in parallel at equal intervals, and outer peripheries of the optical fibers 12 are covered with connecting material 15. The optical fibers 12 are connected with the connecting material 15, at positions where they are adjacent to each other. Specifically, the optical fiber ribbon 11 has such a structure that the optical fibers 12 are covered with the connecting material 15, and connected with each other in connection parts 16 to be integrated. In a state where the optical fibers 12 are integrated with the connecting material 15, an outer diameter of the optical fiber ribbon 11 including the connecting material 15 at respective positions of the optical fibers 12 is, for example, 260 μm.

In this optical fiber ribbon 11, concave parts 15a are formed in the connection parts 16 of the connecting material 15 which covers the outer peripheries of the optical fibers 12, corresponding to recesses formed between the adjacent optical fibers 12. Each of the concave parts 15a has a shape of a so-called “notch” which has an acute angle in its deepest bottom. However, the bottom may be formed in a concave shape having a moderate curve.

This optical fiber ribbon 11 is formed in such a manner that a thickness a of the connecting material 15 in each of the connecting parts 16 in a direction perpendicular to an arranging direction of the optical fibers 12, which is a distance between the two concave parts 15a on a front side and a back side, is smaller than an outer diameter d of the optical fiber 12. This outer diameter d of the optical fiber 12 is set to be about 250±15 μm, for example, 255 μm. In this case, the thickness a of the connecting material 15 in the connecting part 16 is preferably from 50 μm to 100 μm.

As the connecting material 15 for the optical fiber ribbon 11, the resin of ultraviolet radiation hardening type or the like, which is a base resin having the same components as the coating layer 14 of the optical fiber 12, is preferably used. The resins of both the coating layer 14 and the connecting material 15 in the optical fiber ribbon 11 contain no releasing agent, or contain only a small amount of the releasing agent. Therefore, a peeling strength, that is, a force per unit length required for peeling off the connecting material 15 from the outer peripheral face of the optical fiber 12 is larger than 0.1 N/mm. In case where the releasing agent is contained in the resin of the coating layer 14 or the connecting material 15 in the optical fiber ribbon 11, the releasing agent of silicone group or fluorine group may be contained at a rate of 10 wt. % or less.

The peeling strength of the connecting material 15 with respect to the outer peripheral face of the optical fiber 12 is measured in the following manner.

The connecting material 15 positioned between one of the optical fibers 12, except the optical fibers 12 at opposite ends in a width direction of the optical fiber ribbon 11 (the arranging direction of the optical fibers 12), and the two optical fibers 12 at both sides of the one optical fiber 12 is cut with a knife or a razor, thereby to detach the one optical fiber 12 from the two adjacent optical fibers 12. Then, the connecting material 15 is separated into pieces upward and downward. One of the separated pieces is grasped and pulled in a direction perpendicular to the longitudinal direction of the optical fibers 12 (in a direction of 90 degree) at a rate of 100 mm/min., and a tensile force on this occasion is measured. A length of the connecting material 15 which has been peeled off is measured from a value of this tensile force, and converted into the peeling strength per a unit length. In case where the connecting material 15 is broken at a time of measuring the tensile force, a bonding agent may be applied to the connecting material 15 or a hardening coating layer may be formed on the connecting material 15 thereby to prevent breakdown of the connecting material 15 at the time of measuring.

Moreover, as shown in FIG. 1, the connecting material 15 of the above described optical fiber ribbon 11 is provided with notches 11a intermittently along the longitudinal direction, between the adjacent optical fibers 12, that is, at positions of the connection parts 16. In other words, in regions where the optical fibers 12 are adjacent to each other in this optical fiber ribbon 11, there exist some parts where the adjacent optical fibers 12 are not connected to each other, intermittently along the longitudinal direction of the optical fibers 12. According to this structure, it is possible to easily separate the optical fiber ribbon 11 into a plurality of the optical fibers 12.

In order to produce the optical fiber ribbon 11, the optical fibers 12 are fed in parallel from a plurality of bobbins, and the optical fibers 12 which are arranged in parallel are covered with the connecting material 15 to be integrated into a tape-like shape, using a tape covering device. Then, the notches 11a are formed in the connecting material 15 intermittently along the longitudinal direction, using a cutting device.

A stack of about five sheets of the optical fiber ribbons 11 are contained in a spiral slot formed in a spacer which constitutes, for example, an aerial optical fiber cable of FTTH service for providing ultrafast communication service. The spiral slot is formed in an “SZ” shape in which a direction of the slot is reversed in the middle, so that the optical fiber ribbons 11 can be easily taken out from the slot.

The optical fiber ribbons 11 which are contained in the slot of the spacer of the optical fiber cable are likely to be flexed in the width direction, because the concave parts 15a are formed in the connecting material 15. Therefore, when the optical fiber ribbons 11 are contained in the slot of the spacer, any constrained force will not be exerted on the optical fiber ribbons 11. Accordingly, a difference in length which occurs, inside the slot, between the optical fibers 12 positioned in outer portion of the cable and the optical fibers 12 positioned in inner portion of the cable is eliminated. In this manner, it is possible to improve PMD (Polarization Mode Dispersion) of the cable.

Moreover, the connecting material 15 of the optical fiber ribbon 11 comes into a nearly round shape along the outer periphery of the optical fiber 12. For this reason, anisotropy of hardening contractive stress of the connecting material 15 during production of the optical fiber ribbon 11 is reduced, and therefore, the PMD of the optical fiber ribbon 11 in a cable form can be improved.

Moreover, in case where the notches 11a formed in the optical fiber ribbon 11 are positioned in a reversal part where the direction of the spiral slot is reversed, it is possible to remarkably decrease the PMD due to anisotropic distortion of the optical fiber ribbon 11.

In order to drop the optical fiber to a subscriber's home from the aerial optical fiber cable which contains the optical fiber ribbons 11, the post-intermediate branching work for withdrawing the optical fiber ribbon 11 from the slot of the aerial optical fiber cable, and separating the optical fiber ribbon 11 into a plurality of the optical fibers 12 or a plurality of optical fiber groups including the optical fibers 12 is conducted. Then, an optical drop cable for dropping the optical fiber 12 to the home of the subscriber of the FTTH service is connected to each of the separated optical fibers 12.

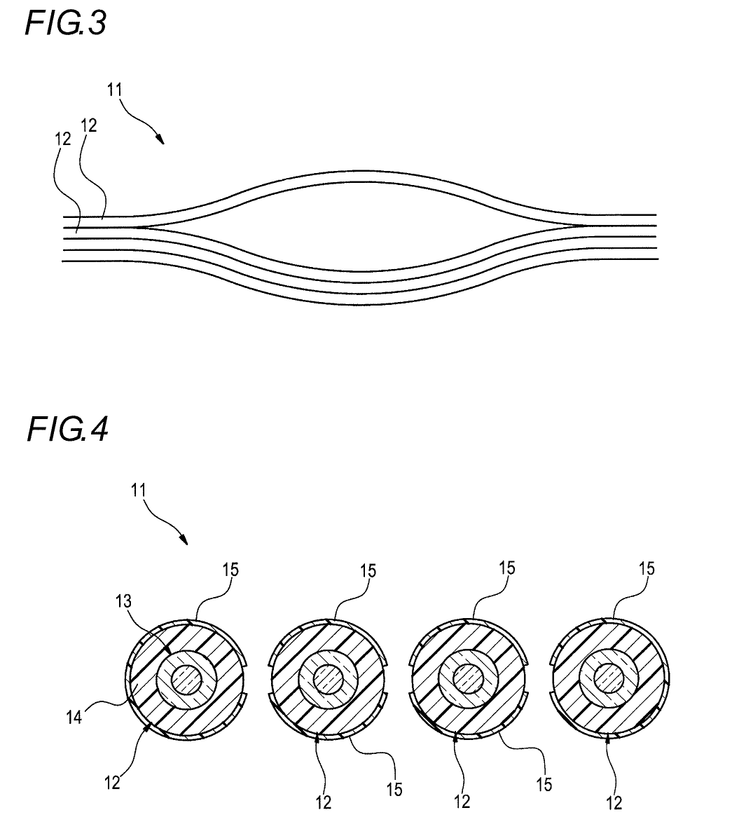

In this post-intermediate branching work, in those regions where the optical fiber ribbon 11 is separated into a plurality of the optical fibers 12 or a plurality of optical fiber groups including the optical fibers 12, the connection parts 16 between the optical fibers 12 are cut along the longitudinal direction, as shown in FIG. 3.

On this occasion, it is possible to extremely easily cut the connecting material 15 in the connection parts 16 between the respective optical fibers 12 thereby to separate the optical fibers 12. This is because the thickness a of the connecting material 15 in a direction perpendicular to the arranging direction of the optical fibers 12 in the connection parts 16, where the optical fibers 12 of the optical fiber ribbon 11 are adjacent to each other, is smaller than the outer diameter d of the optical fibers 12 (See FIG. 2). Particularly, because the connecting material 15 of the optical fiber ribbon 11 is provided with the notches 11a, between the adjacent optical fibers 12, intermittently along the longitudinal direction, the cutting work in the connection parts 16 between the adjacent optical fibers 12 can be more easily conducted.

Moreover, in the optical fiber ribbon 11, the peeling strength of the connecting material 15 with respect to the outer peripheral faces of the optical fibers 12 is larger than 0.1 N/mm. Therefore, even though the optical fiber ribbon 11 is separated into a plurality of the optical fibers 12 or a plurality of optical fiber groups including the optical fibers 12, the connecting material 15 will not be peeled off from the outer peripheral faces of the separated optical fibers 12, and kept in tight contact with the outer peripheral faces, as shown in FIG. 4.

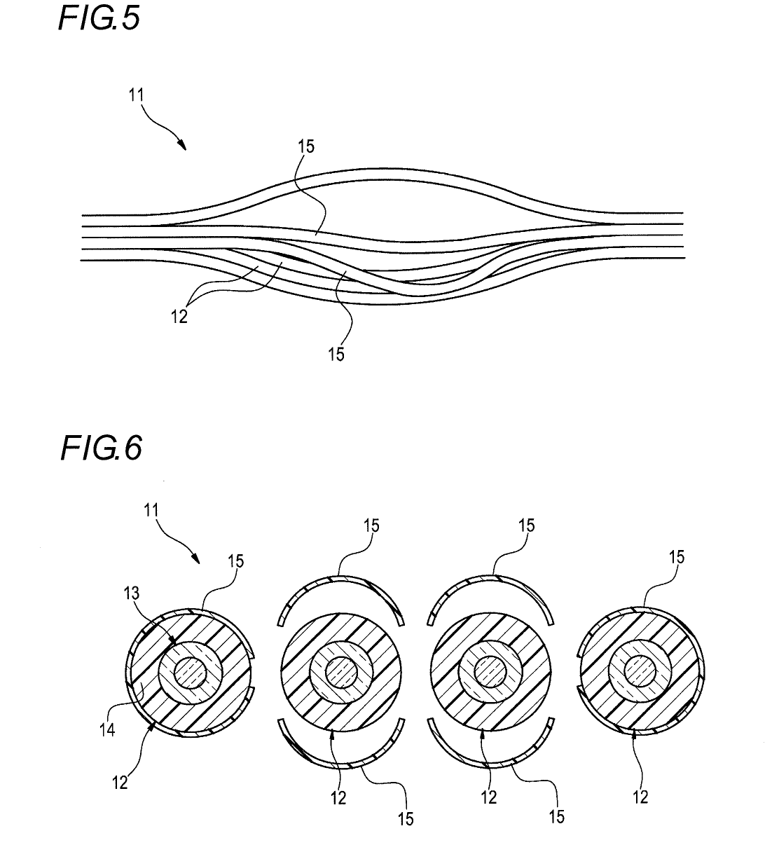

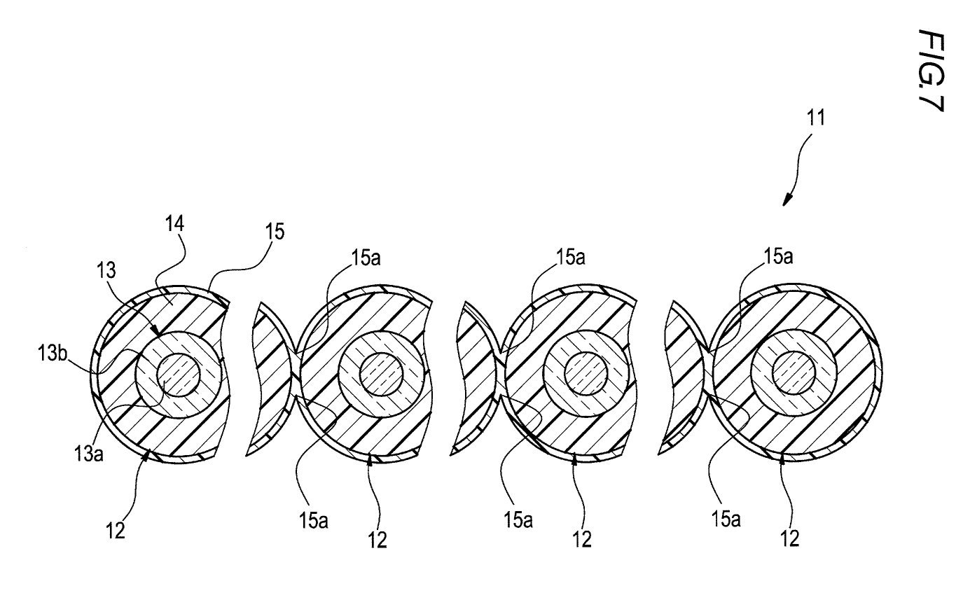

In case where the peeling strength of the connecting material 15 with respect to the outer peripheral faces of the optical fibers 12 is smaller than 0.1 N/mm, in the optical fiber ribbon 11, when the optical fiber ribbon 11 is separated into the optical fibers 12, as shown in FIGS. 5 and 6, the connecting material 15 of the separated optical fibers 12 is divided into pieces upward and downward. As the results, the connecting material 15 is kept in tight contact with the outer peripheral faces of the optical fibers 12 only in areas less than a half in a circumferential direction, and naturally, the connecting material 15 is peeled off from the outer peripheral faces. It is to be noted that in case of the optical fibers 12 positioned at the opposite sides, the connecting material 15 is applied to areas more than a half in the circumferential direction, and therefore, removal of the connecting material 15 from the outer peripheral faces of the optical fibers 12 is restrained. This removal of the connecting material 15 from the outer peripheral faces of the optical fibers 12 mainly occurs in the optical fibers 12, except the optical fibers 12 positioned at the end portion along the width direction.

Then, the connecting material 15 which has been peeled off from these optical fibers 12 will be an obstacle to the succeeding branching work in a connecting work for connecting the optical fibers 12 to the drop cable. Moreover, this connecting material 15 which has been peeled off is cut away from the optical fiber ribbon 11 to be disposed as waste, and therefore, it is necessary to perform the annoying separating work and waste disposal.

In contrast, according to the optical fiber ribbon 11 in this embodiment, even though the optical fibers 12 are separated, the connecting material 15 will not be peeled off from the outer peripheral faces of the separated optical fibers 12, but will be kept in a tightly contacted state. In this manner, it is possible to extremely smoothly and reliably perform the succeeding branching work in the connecting work with respect to the drop cable, and to reduce the working time for the post-intermediate branching work. Moreover, because the connecting material 15 is not peeled off on this occasion, it is possible to eliminate necessity of such annoying works as cutting away the connecting material 15 which has been peeled off, from the optical fiber ribbon 11 to be disposed as waste.

On the other hand, in case where the peeling strength is larger than 10 N/mm (10 kg/cm), the resin (the coating layer 14) of the optical fibers 12 will be damaged, when the optical fiber ribbon 11 is separated into the optical fibers 12, as shown in FIG. 7.

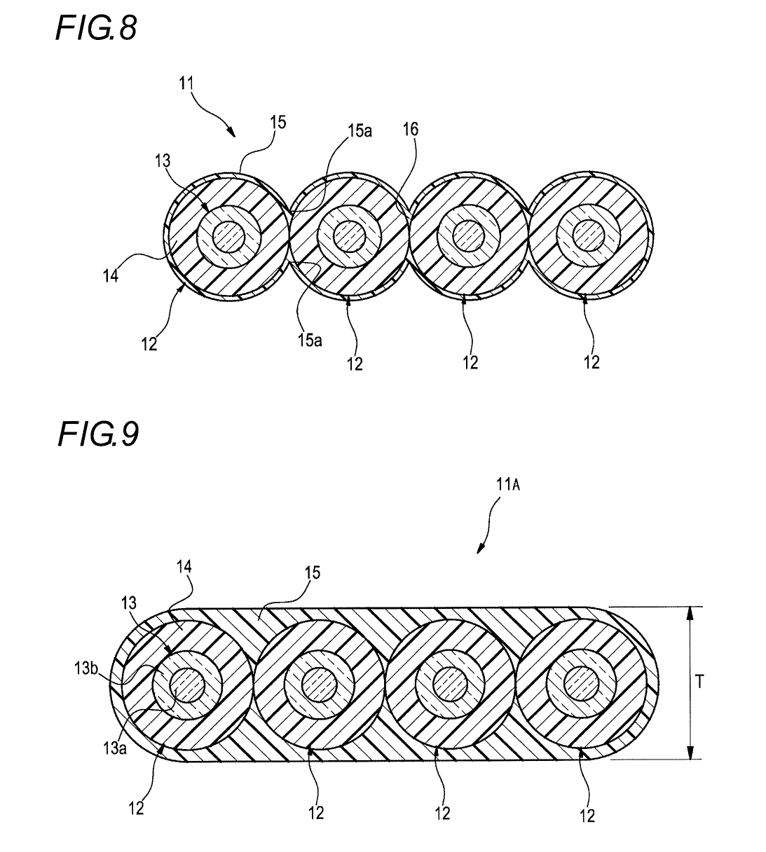

Although the optical fiber ribbon 11 as shown in FIG. 1 has such a structure that the connecting material 15 is interposed between the adjacent optical fibers 12, it is also possible to integrate the optical fibers 12 with the connecting material 15, in a state where the adjacent optical fibers 12 are in contact with each other, as shown in FIG. 8. In this case, it is possible to make a width size of the optical fiber ribbon 11 as small as possible, and to decrease an amount of the resin in the connecting material 15 thereby to reduce the cost. In case of this structure, when the optical fibers 12 are separated, there remains no connecting material 15 at separating positions. Accordingly, the outer peripheral faces of the optical fibers 12 are partly exposed. However, the optical fibers 12 positioned at the opposite ends have the connecting material 15 remained on one of side faces thereof, even after the optical fibers 12 have been separated. Therefore, a width of the optical fibers 12 at the opposite ends after the separation is larger than a width of the optical fibers 12 positioned in the middle. For this reason, in case where the width of all the optical fibers 12 after the separation is to be equal between the respective separating positions, the structure in which the connecting material 15 is interposed between the adjacent optical fibers 12 is preferably adopted.

### Second Embodiment

FIG. 9 shows an optical fiber ribbon 11A in a second embodiment according to the invention. In a sectional view taken in a direction perpendicular to an axis, as shown in FIG. 9, opposite ends of the optical fiber ribbon 11A in a width direction have a semicircular shape along the optical fibers, while upper and lower ends thereof have a linear shape. A thickness T of the optical fiber ribbon 11A is “d+50 μm” to “d+150 μm”, wherein d is the outer diameter of the optical fiber 12.

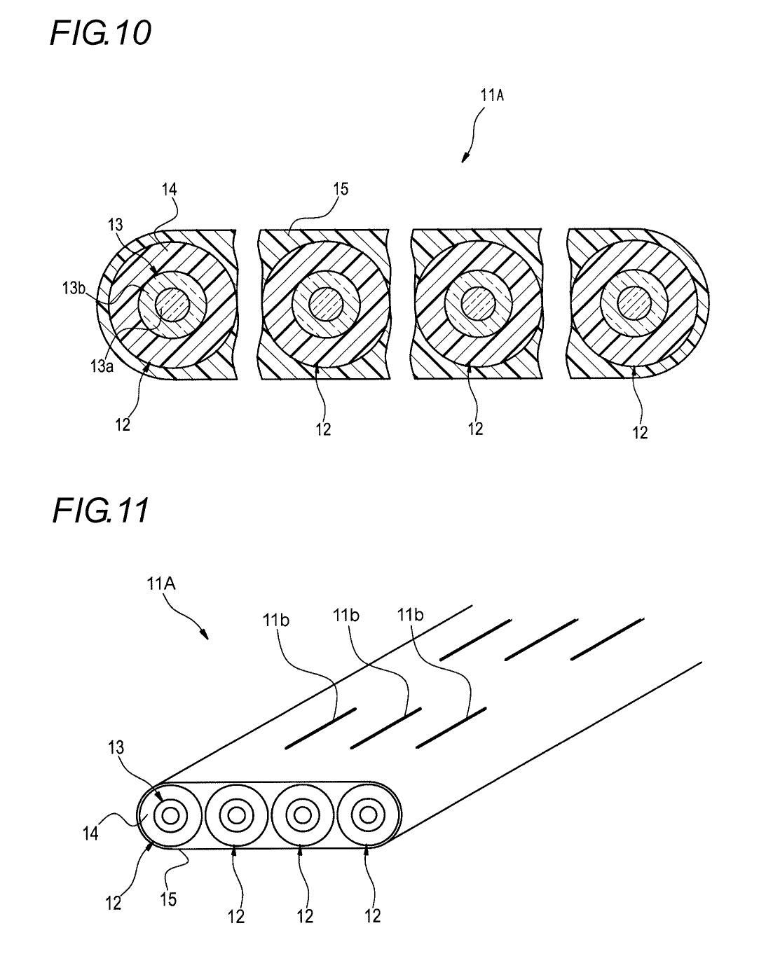

FIG. 10 is a view showing the optical fiber ribbon 11A as shown in FIG. 9, in a separated state. In this case too, the connecting material 15 is kept in tight contact with the outer peripheral faces of the optical fibers 12 without being peeled off, because the peeling strength of the connecting material 15 with respect to the outer peripheral faces of the optical fibers 12 is set to be from 0.1 N/mm to 10 N/mm.

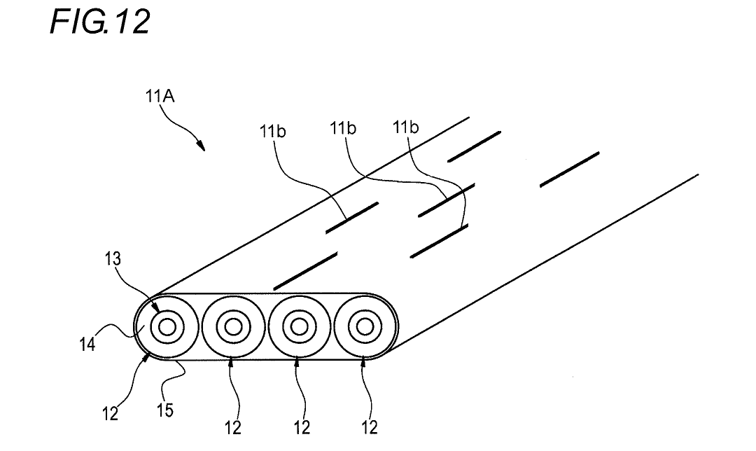

As shown in FIG. 11, it is preferable that those parts where the optical fibers 12 are not connected with each other are present intermittently along the longitudinal direction, in the regions where the optical fibers 12 are adjacent to each other. Specifically, it is preferable that notches 11b are formed in the connecting material 15 between the optical fibers 12, intermittently along the longitudinal direction. According to this structure, the optical fiber ribbon 11A can be easily separated into a plurality of the optical fibers 12.

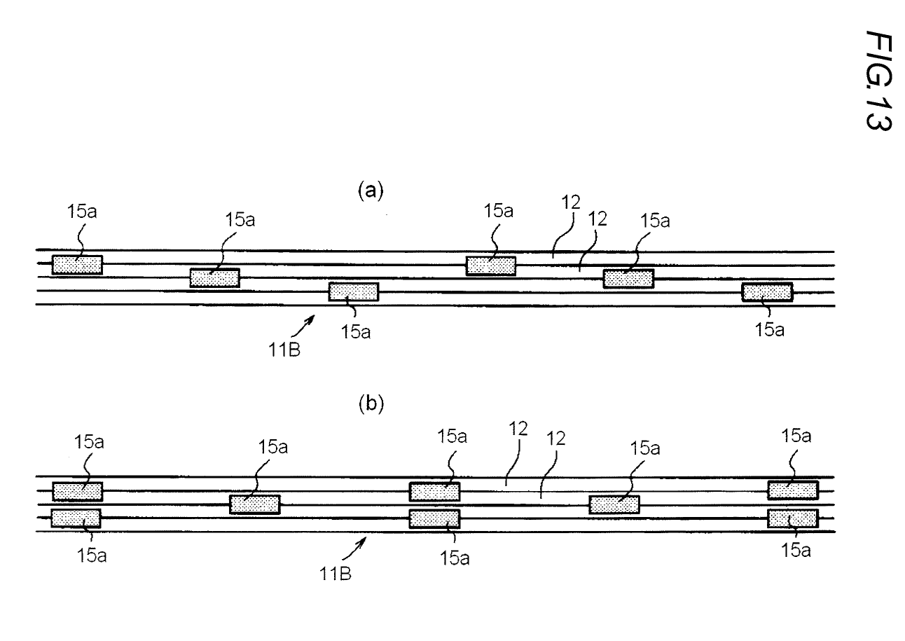

It is to be noted that the notches 11b may be formed in a staggered manner, as shown in FIG. 12. Also in the optical fiber ribbon 11 as shown in FIG. 1, the notches 11a may be formed in a staggered manner.

### Third Embodiment

FIG. 13 shows an optical fiber ribbon 11B in a third embodiment according to the invention. As shown in FIG. 13(a), in this optical fiber ribbon 11B, there exist some parts where the optical fibers 12 are not connected to each other, in those regions where the optical fibers 12 are adjacent to each other, intermittently along the longitudinal direction of the optical fibers 12. Specifically, in the third embodiment, different from the first and second embodiments, an entire periphery of a plurality of the optical fibers 12 which are arranged at equal intervals is not covered with the connecting material 15, but the adjacent optical fibers 12 are bonded and connected to each other with connecting material 15a, intermittently at only several positions. Therefore, there exist some parts where the connecting material 15a are not applied, intermittently along the longitudinal direction of the optical fibers 12. In this case too, the peeling strength of the connecting material 15 with respect to the outer peripheral faces of the optical fibers 12 is set to be from 0.1 N/mm to 10 N/mm. According to this structure, it is possible to easily separate the optical fiber ribbon 11B into a plurality of the optical fibers 12 in the post-intermediate branching work, without deteriorating containing performance for containing the optical fiber ribbon 11B in a groove of the slot and workability on occasion of conducting integral melting connection.

It is to be noted that the adjacent connecting material 15a may be arranged apart from each other, as shown in FIG. 13(a). Alternatively, the adjacent connecting material 15a may be arranged at the same positions in the arranging direction of the optical fibers 12, although they are apart from each other, as shown in FIG. 13(b).

### DESCRIPTION OF THE REFERENCE NUMERALS AND SIGNS

11, 11A, 11B Optical fiber ribbon
11a, 11b Notch
12 Optical fiber
13 Glass fiber
15, 15a Connecting material
a: Thickness
d: Outer diameter

1. An optical fiber ribbon comprising a plurality of optical fibers which are formed of glass fibers coated with resin, and arranged in parallel, the optical fibers being connected with connecting material,
wherein a peeling strength of the connecting material with respect to outer peripheral faces of the optical fibers is set to be from 0.1 N/mm to 10 N/mm.

2. An optical fiber ribbon according to claim 1, characterized in that in regions where the optical fibers are adjacent to each other, there exist some parts where the optical fibers are not connected with each other, intermittently along a longitudinal direction of the optical fibers.

3. An optical fiber ribbon according to claim 2, characterized in that there exist some parts where the connecting material is not applied, intermittently along the longitudinal direction.

4. An optical fiber ribbon according to claim 2, characterized in that notches are formed in the connecting material between the optical fibers, intermittently along the longitudinal direction.

5. An optical fiber ribbon according to claim 6, characterized in that in a sectional plane perpendicular to an axis of the optical fiber ribbon, a thickness of the connecting material in a direction perpendicular to an arranging direction of the optical fibers, in the regions where the optical fibers are adjacent to each other, is smaller than an outer diameter of the optical fiber.

6. An optical fiber ribbon according to claim 1, characterized in that when the optical fiber ribbon is separated into a plurality of the optical fibers or a plurality of optical fiber groups including the optical fibers, the connecting material is kept in tight contact with the outer peripheral faces of the separated optical fibers.
